(19) United States
(12) Patent Application Publication
(10) Pub. No.: US 2021/0331814 A1
(43) Pub. Date: Oct. 28, 2021

(54) SIGNAL GENERATOR FOR AN UNMANNED AIRCRAFT, UNMANNED AIRCRAFT, AND METHOD OF GENERATING A SIGNAL AT AN UNMANNED AIRCRAFT

(71) Applicant: LIFTAIR GmbH, Hörselberg-Hainich (DE)

(72) Inventor: Matthias BETSCH, Hörselberg-Hainich (DE)

(21) Appl. No.: 16/316,590

(22) PCT Filed: Jul. 24, 2018
(86) PCT No.: PCT/EP2018/070043

§ 371 Date: Jan. 9, 2019

(30) Foreign Application Priority Data
Jul. 24, 2017 (DE) 10 2017 116 700.5

(51) Int. Cl. B64D 47/06

(52) U.S. Cl. CPC B64D 47/06; B64C 39/024

(57) ABSTRACT

The invention relates to a signal generator for unmanned aircraft comprising at least one light source and/or at least one sound source and at least one regulator/control for actuating the at least one source.

The invention relates to a signal generator for unmanned aircraft comprising at least one light source and/or at least one sound source and at least one regulator/control for actuating the at least one light source and/or sound source.

Unmanned aircraft or drones are known from the prior art that are used increasingly, privately or commercially, in air space, for example for the delivery of shipments or as a toys.

Such aircraft here typically fly at a low altitude and at a moderately fast speed. The weights of the aircraft are typically between near 0 kg and 1200 kg and will in future also probably be able to amount to more.

These aircraft are will probably also fly in large numbers over highly populated areas and will therefore require a protective device for the event that their drives or uplift and/or their navigation systems fail. In such failure cases, the protection of persons and/or objects located in the vicinity and also of the aircraft itself must be ensured.

Measures for so-called envelope protection are known for this purpose from the prior art in which the possible flight maneuvers of the aircraft can be restricted, wherein, for example, permitted speeds and/or G-loads can be limited and/or wherein the air space can be restricted, for example, with respect to its permitted altitude or with respect to its permitted zone above ground. It is furthermore known here to transmit current flight data via a transponder to a receiver for the purpose of flight control.

Parachutes are furthermore known that are opened by a pull-out mechanism when the aircraft threatens to crash. In these parachutes, an opening impact acts on the aircraft during the unfolding process.

The opening impact can be reduced via the packaging of the parachute, via the materials used and/or via an opening delayer or a slider. Experimentally, there are also systems with a glide angle, with these being disadvantageously heavy and with their control being complex.

Against this background, it is the object of the invention to provide an improved unmanned aircraft or a signal generator for a corresponding unmanned aircraft in which the safety of the aircraft and its environment can be improved.

This object is achieved in accordance with the invention by a signal generator for unmanned aircraft having the features of claim 1. Advantageous embodiments are the subject of the dependent claims.

A signal generator for unmanned aircraft is accordingly provided comprising at least one light source and/or at least one sound source and at least one regulator/control for actuating the at least one light source and/or sound source.

Provision is made in accordance with the invention that the at least one source is in particular automatically actuable in dependence on at least one state of danger. The light source and/or the sound source can be meant by the term source.

If such a state of danger is recognized, the light source can transmit light signals and/or the sound source can transmit sound signals that can heard or seen, for example, by persons present in the vicinity.

The persons can be persons who are present in a danger zone, for example, below a crashing aircraft and whose attention can be drawn to the risk of the crashing aircraft by means of the signal generator in accordance with the invention and who can thereby react accordingly.

It is conceivable in a preferred embodiment of the invention that the state of danger is a controlled and/or uncontrolled crash and/or a collision of the aircraft, with means being provided to recognize a corresponding state of danger. The means can here comprise corresponding acceleration sensors, speed sensors and/or position sensors.

Provision can be made in a particularly preferred embodiment for the means to comprise a navigation device that is configured to transmit information to the regulation/control to actuate the source. The regulation/control can then recognize from the information obtained whether a state of danger is present and it can furthermore actuate, i.e. activate, the sound source and/or the light source.

Provision can be made in a further preferred embodiment that the means comprise an independent trigger system inherent to the system.

Provision can be made in a further preferred embodiment that the sound source is electrically and/or pneumatically operated. The sound source can, for example, be configured as an optionally combined loudspeaker and/or siren.

It is conceivable in a further preferred embodiment that the regulation/control is adapted to actuate the source on an exceeding of at least one of the basic parameters.

In a particularly preferred embodiment, the basic parameter can be a horizontal and/or vertical flight attitude and/or a speed parameter of the aircraft.

It is conceivable in a further preferred embodiment that the signal output by the source is a single signal and/or a multiple signal and/or a continuous signal and/or an interval signal and/or that the signal output by the source is variable in its frequency. The kind of signal can here be linked to the kind of danger situation.

For example, different kinds of signals can indicate that the aircraft is in free fall, that the aircraft is in an uncontrolled fall using a parachute, or is in a controlled fall using a parachute. Depending on the danger potential, correspondingly differently urgent or conspicuous signals can be selected.

A free fall without a parachute can, for example, be indicated by a continuous signal or by an interval signal having small or reducing intervals.

An uncontrolled fall with a parachute can in contrast be indicated by a multiple signal and a controlled fall can be indicated by a single signal or by a specific number of single signals.

The invention is further directed to an unmanned aircraft having at least one signal generator in accordance with one of the claims 1 to 8.

The invention also relates to a method of generating a signal at an unmanned aircraft, the method comprising the steps:
i. recognizing a state of danger; and
ii. generating a signal in dependence on the state of danger.

The method can in particular be carried out by means of a signal generator in accordance with one of the claims 1 to 8 and further in particular by means of an unmanned aircraft in accordance with claim 9.

The method can furthermore comprise further features that correspond to or are related to the apparatus features of claims 1 to 8.

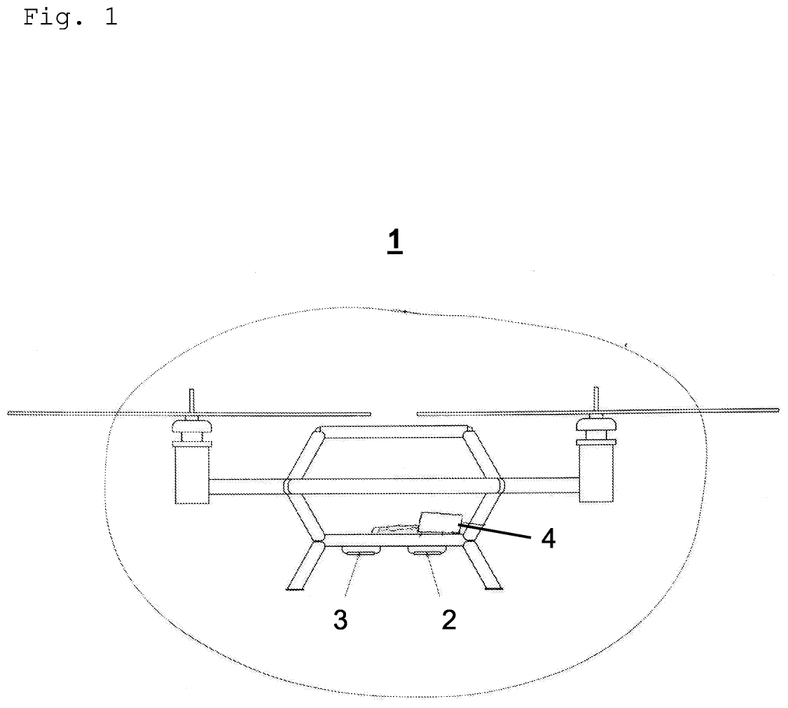

Further details and advantages of the invention are explained with reference to the embodiment shown by way of example in FIG. 1.

The only FIG. 1 shows the schematic view of an unmanned aircraft 1 in accordance with the invention that can be configured as a multicopter. The aircraft 1 can comprise a plurality of motors, in particular electric motors, and thus in particular directly coupled propellers, that is propellers coupled without a transmission.

At least one light source 3 and/or at least one sound source 2 can be provided at a lower side of the aircraft 1. The light source 3 and the sound source 2 can be actuated or engaged via a regulation/control.

The light source 3 and/or the sound source 2 can in particular transmit light or sound downwardly in a manner directed away from the aircraft 1.

It is conceivable that both a light source 3 and a sound source 2 are provided. Means for recognizing a state of danger can be provided at the aircraft 1.

The means can, for example, comprise a navigation device that is adapted to transmit information to a regulation/control, not shown, of the aircraft.

The aircraft 1 can comprise an internal navigation system, an independent trigger system 4 inherent to the system, or other means of recognizing a state of danger. They can be coupled to the regulation/control and can influence the triggering of the sound source 2 and/or of the light source 3.

1. A signal generator for unmanned aircraft comprising at least one light source and/or at least one sound source as well as at least one regulation/control for actuating the at least one light source and/or the at least one sound source, wherein in that the at least one light source and/or sound source is actuable in dependence on at least one state of danger.

2. The signal generator in accordance with claim 1, wherein the state of danger is a controlled and/or uncontrolled crash and/or a collision of the aircraft, with a device being provided for recognizing a corresponding state of danger.

3. The signal generator in accordance with claim 2, wherein the device comprises a navigation device that is adapted to transmit information to the regulation/control for actuating the light source or the sound source.

4. The signal generator in accordance with claim 2, wherein the device comprises an independent trigger system inherent to the system.

5. The signal generator in accordance with claim 1, wherein the sound source is electrically and/or pneumatically operated.

6. The signal generator in accordance with claim 1, wherein the regulation/control is adapted to actuate the light source or the sound source on an exceeding of at least one basic parameter.

7. The signal generator in accordance with claim 6, wherein the basic parameter is a horizontal and/or vertical flight attitude and/or a speed parameter of the aircraft.

8. The signal generator in accordance with claim 1, wherein the signal output by the light source or sound source is a single signal and/or a multiple signal and/or a continuous signal and/or an interval signal; and/or in that the signal output by the light source or sound source is variable in its frequency.

9. An unmanned aircraft having at least one signal generator comprising at least one light source and/or at least one sound source as well as at least one regulation/control for actuating the at least one light source and/or the at least one sound source, wherein in that the at least one light source and/or sound source is actuable in dependence on at least one state of danger.

10. A method of generating a signal at an unmanned aircraft, the method comprising the steps:
recognizing a state of danger;
generating a signal in dependence on the state of danger.

11. The method of claim 10 wherein the signal generator comprises at least one light source and/or at least one sound source as well as at least one regulation/control for actuating the at least one light source and/or the at least one sound source, wherein in that the at least one light source and/or sound source is actuable in dependence on at least one state of danger to generate the signal.
